(19) United States
(12) Patent Application Publication
(10) Pub. No.: US 2008/0241633 A1
(43) Pub. Date: Oct. 2, 2008

(54) Direct oxide fuel cell

(75) Inventors: Cheng Wang, Hsinchu (TW); Jin-Shu Huang, Hsinchu (TW); Ching-Po Lee, Hsinchu (TW); Nien-Hui Hsu, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsinchu (TW)

(21) Appl. No.: 12/007,884

(22) Filed: Jan. 16, 2008

(30) Foreign Application Priority Data
Mar. 30, 2007 (TW) 096111371

(51) Int. Cl. H01M 8/04

(52) U.S. Cl. 429/34

(57) ABSTRACT

A direct oxide fuel cell includes a membrane electrode assembly (MEA), an anode collector, a cathode collector, an anode flow channel plate, and an equalization structure. The anode collector and the cathode collector are disposed on two sides of the MEA respectively. The anode collector contains a plurality of through zones surrounded and a non-through zone. The anode flow channel plate is disposed on a side of the anode collector facing away from the MEA, and includes a fuel transmission channel. The equalization structure disposed in the fuel transmission channel has an end connected to the anode flow channel plate and an opposite end abutting against the anode collector. An area of non-through zones abutted by the equalization structure is bigger than an area of the through zones abutted by the equalization structure.

### FIELD OF THE INVENTION

The present invention relates to a fuel cell, and in particular to a direct oxide fuel cell.

### BACKGROUND OF THE INVENTION

Referring to FIGS. 1 and 2 of the attached drawings, a conventional direct oxide fuel cell (DOFC), generally designated with reference numeral 100, is shown. The direct oxide fuel cell 100 is a special type of fuel cells, and has an anode that consumes an oxide fuel, which may include compounds containing carbon, hydrogen, and oxygen. An example of the oxide fuels is alcohol fuels, such as methanol. Other compounds may also be used. The oxide fuel may be dissolved in water and water may participate in the chemical reaction that the fuel cell takes for generation of electricity. The direct oxide fuel cell 100 comprises a membrane electrode assembly (MEA) 1. The membrane electrode assembly 1 has a cathode side 11 and an anode side 12. A cathode collector 111 is disposed on the cathode side 11 of the membrane electrode assembly 1 and an anode collector 121 is disposed on the anode side 12 of the membrane electrode assembly 1.

The anode collector 121 has through areas 121a and a non-through area 121b. An anode flow channel plate 13 is disposed on the surface of the anode collector 121 that is facing away from to the membrane electrode assembly 1. The anode flow channel plate 13 has a fuel-inlet-side wall 13a in which a fuel inlet 131 is defined, a fuel-outlet-side wall 13b in which a fuel outlet 132 is defined, and two opposite lateral side walls 13c, 13d. The walls 13a, 13b, 13c, 13d delimit a fuel transmission channel 133. An island area 14 is set in the fuel transmission channel 133 substantially at a central zone thereof The island area 14 comprises an equalization plate 141, which is a solid triangular prism. The equalization plate 141 is arranged as an inverted triangle as viewed in a direction from the fuel inlet 131 to the fuel outlet 132, having an obtuse angle apex 141a opposing the fuel inlet 131 and two acute angle apexes 141b, 141c.

The oxide fuel Fin for the anode flows through the fuel inlet 131 into the fuel transmission channel 133, and a fuel jet stream F is formed. The fuel jet stream F encounters and is thus split by the obtuse apex 141a of the equalization plate 141 into two branch streams F1, F2, which respectively flow over the acute apexes 141b, 141c and combine together in a convergence zone 15 of the fuel transmission channel 133 and then flows in a flow direction I through the fuel outlet 132 to get out of the anode flow channel plate 13.

The island area 14 located inside the fuel transmission channel 133 is constituted by a single, solid equalization plate 141. Thus, a circulation zone 151 is present in the fuel transmission channel 133 behind the back side of the equalization plate 141 that extends between the two acute apexes 141b, 141c. This makes the flow field induced in the fuel transmission channel 133 distributed in a non-uniform manner. And, products of the reaction occurring in the anode side, such as CO₂, are not easy to get out of the circulation zone 151, whereby a reversed reaction may locally occur. Further, the anode collector 121 is adhesively mounted to the walls 13a, 13b, 13c, 13d of the anode flow channel plate 13 with an adhered edge of a width of around 3 mm. The adhered edge may block partially the through areas 121a, and thus influences the reaction of the oxide, inducing a reversed potential and reducing the reaction rate of the fuel cell. Further, the anode flow channel plate 13 applies a force through the equalization plate 141 to have the membrane electrode assembly 1 and the anode collector 121 in tight engagement with each other, but the equalization plate 141 blocks some of the through areas 121a of the anode collector 121 so that the oxide fuel Fin and the reaction product, such as CO₂, cannot be exchanged with the outside materials, leading to the reverse reaction, such as electrolysis of water and oxidation of carbon particles. This increases the anode potential and thus reduces the overall potential difference and the output power. Moreover, the consumption of the carbon particles due to oxidation thereof may result in damage to the structure of the diffusion layer of the membrane electrode assembly, thereby causing a reverse influence on the power output and the reliability of the fuel cell.

Thus, it is desired to have an improved direct oxide fuel cell that overcomes the above drawbacks of the conventional direct oxide fuel cell.

### SUMMARY OF THE INVENTION

The present invention is to provide a direct oxide fuel cell, which reduces the occurrence of reversed reaction in anode collector, eliminates the fuel circulation at the fuel transmission channel, effectively increases the contact area between methanol and the anode collector, and realizes uniform flow of fuel therethrough.

A direct oxide fuel cell includes a membrane electrode assembly (MEA), an anode collector, a cathode collector, an anode flow channel plate, and an equalization structure. The anode collector and the cathode collector are disposed on two sides of the MEA respectively. The anode collector contains a plurality of through zones and a non-through zone. The anode flow channel plate is disposed on a side of the anode collector facing away from the MEA, and includes a fuel transmission channel. The equalization structure disposed in the fuel transmission channel has an end connected to the anode flow channel plate and an opposite end abutting against the anode collector. An area of non-through zones abutted by the equalization structure is bigger than an area of the through zones abutted by the equalization structure.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The present invention will be apparent to those skilled in the art by reading the following description of preferred embodiments thereof, with reference to the attached drawings, in which:

FIG. 1 is an exploded view of a conventional fuel cell, of which an equalization structure is shown;

FIG. 2 is a cross-sectional view of the conventional fuel cell;

FIG. 3 is an exploded view of a direct oxide fuel cell constructed in accordance with a first embodiment of the present invention;

FIG. 4 is a cross-sectional view of the direct oxide fuel cell in accordance with the first embodiment of the present invention;

FIG. 5 is a top view of the direct oxide fuel cell in accordance with the first embodiment of the present invention;

FIG. 6 is a top view similar to FIG. 5, but illustrating a modification of the direct oxide fuel cell of the first embodiment of the present invention;

FIG. 7 is a cross-sectional view of an equalization structure in accordance with a second embodiment of the present invention;

FIG. 8 is a cross-sectional view of a direct oxide fuel cell constructed in accordance with the second embodiment of the present invention;

FIG. 9 is a cross-sectional view of a direct oxide fuel cell constructed in accordance with a third embodiment of the present invention;

FIG. 10 is a perspective view of an anode flow channel plate of a direct oxide fuel cell constructed in accordance with a fourth embodiment of the present invention, illustrating a equalization structure thereof;

FIG. 11 is a cross-sectional view of the direct oxide fuel cell in accordance with the fourth embodiment of the present invention;

FIGS. 12A-12C respectively show flow field distribution of an oxide fuel flowing through the anode flow channel plate of the direct oxide fuel cell of the fourth embodiment of the present invention;

FIG. 13 is a perspective view similar to FIG. 10, but showing a modification of the equalization structure of the direct oxide fuel cell of the fourth embodiment; and

FIG. 14 is a perspective view of an anode flow channel plate of a direct oxide fuel cell constructed in accordance with a fifth embodiment of the present invention, illustrating a equalization structure thereof.

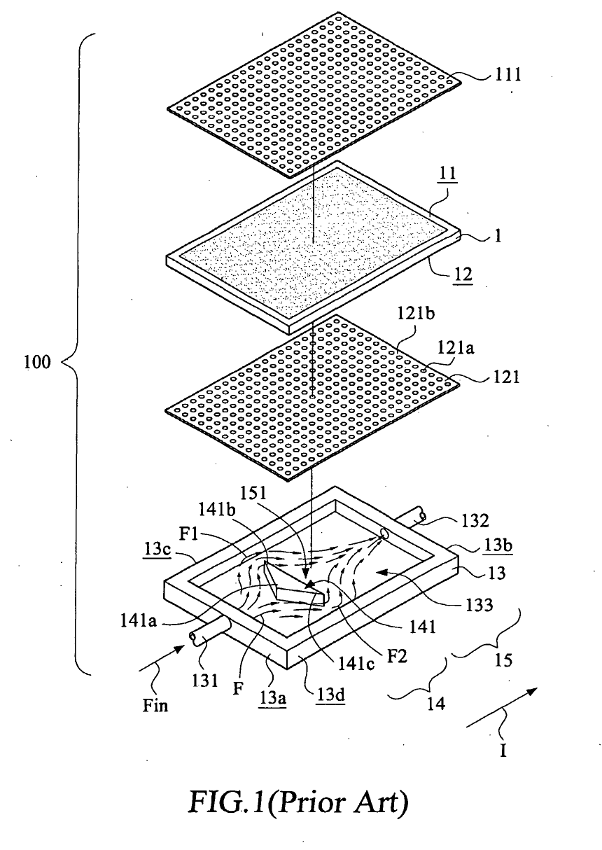

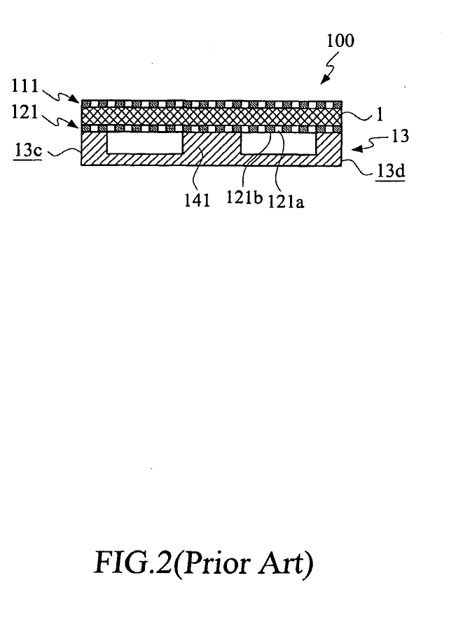

### DETAILED DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

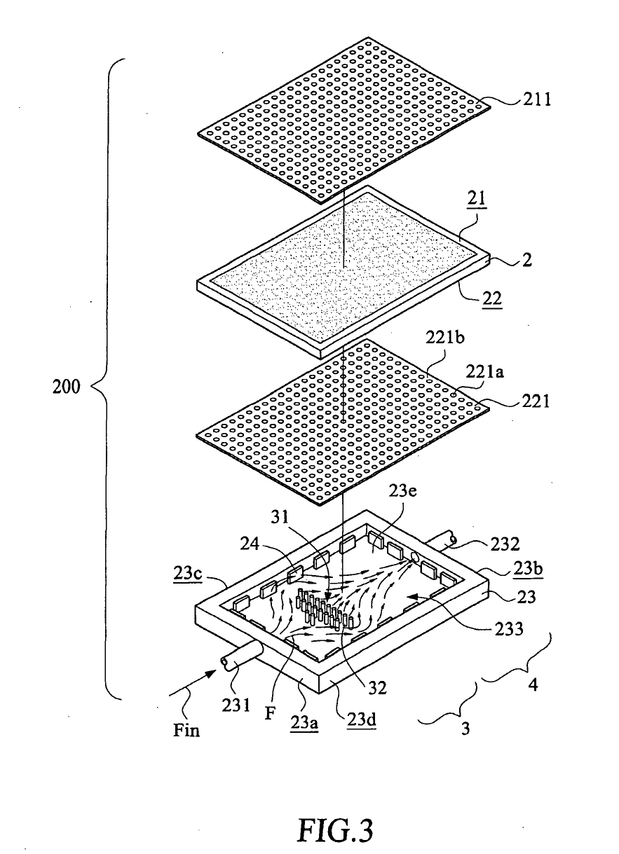

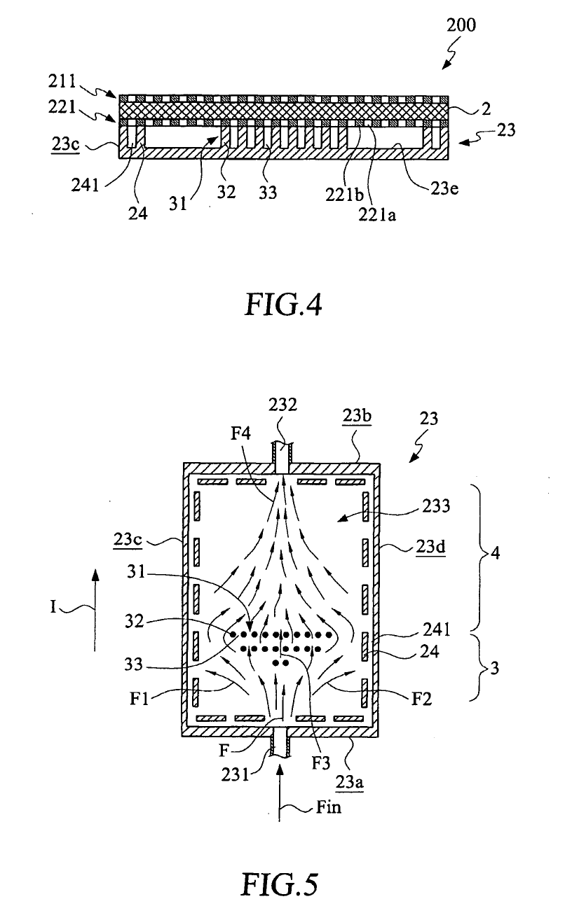

With reference to the drawings and in particular to FIGS. 3 and 4, a direct oxide fuel cell constructed in accordance with a first embodiment of the present invention, generally designated with reference numeral 200, is shown. The direct oxide fuel cell includes a membrane electrode assembly (MEA) 2, an anode collector 221, a cathode collector 211, an anode flow channel plate 23, and an equalization structure 31. The MEA 2 has a cathode side 21 and an anode side 22. The cathode collector 211 is disposed on the cathode side 22, while the anode collector 221 is disposed on the anode side 21. The anode collector 221 contains a plurality of through zones 221a and non-through zones 221b. The anode flow channel plate 23 is disposed on a side of the anode collector 221 facing away from the MEA 2. The anode flow channel plate 23 comprises a first wall 23a in which a fuel inlet 231 is formed, a second wall 23b in which a fuel outlet 232 is formed and opposing the first wall 23a, two lateral side walls 23c, 23d opposite to each other, and a bottom plate 23e. The walls 23a, 23b, 23c, 23d are disposed along a circumference of the bottom plate 23e and top sides of the walls 23a, 23b, 23c, 23d are coupled to the anode collector 221. Consequently, the anode collector 221, the walls 23a, 23b, 23c, 23d, and the bottom plate 23e of the anode flow channel plate 23 delimit a fuel transmission channel 233.

A fluid equalization zone 3 is set substantially at a central location of the fuel transmission channel 233. In the fluid equalization zone 3, a plurality of fluid guiding blocks or bosses or projections 32, preferably comprising round or cylindrical members, are arranged in a mutually-spaced manner to form the equalization structure 31 that is disposed between the fuel inlet 231 and the fuel outlet 232. The fluid guiding blocks 32 are spaced from each other in a direction substantially parallel to the first wall 23a and an open space or gap 33 is present between adjacent fluid guiding blocks 32. The open space 33 corresponds to the through zones 221a of the anode collector 221, and each of the fluid guiding blocks 32 abuts against the non-through zone 221b of the anode collector 221.

Preferably, the fluid guiding blocks 32 are arranged in more than one row, such as three rows illustrated in FIG. 3, and each row contains different number of fluid guiding blocks 32 spaced in the direction parallel to the first wall 23a of the anode flow channel plate 23 whereby the fluid guiding blocks 32 are arranged to form an area of an inverted triangle as viewed in a direction from the fuel inlet 231 to the fuel outlet 232.

The equalization structure 31, the anode flow channel plate 23, and the anode collector 221 together provide such a construction that the equalization structure 31 has an end (the lower side) connected to the anode flow channel plate 23 and an opposite end (the upper side) abutting against the anode collector 221 and an area of the non-through zone 221b abutted by the equalization structure 31 is bigger than an area of the through zones 221a abutted by the equalization structure 31.

Further, each fluid guiding block 32 provides a force to facilitate securing of the MEA 2 of the fuel cell 200 and also enhances uniformization of a fuel jet stream F flowing into the anode flow channel plate 23 so as to induces a substantially uniform distribution of flow field of fuel inside the anode flow channel plate 23.

Also referring to FIG. 5, the fuel transmission channel 233 contains a convergence zone 4 that is formed between the fluid equalization zone 3 of the fuel transmission channel 233 and the fuel outlet 232. Anode fuel Fin flows into the anode flow channel plate 23 through the fuel inlet 231 as a fuel jet stream F, which travels along the fuel transmission channel 233 and moves through the fluid equalization zone 3 where the fuel stream F passes through the open spaces 33 between the fluid guiding blocks 32 of the equalization structure 31 to form separate branch streams F1, F2, F3. The branch fuel streams F1, F2, F3, after passing the equalization structure 31, converge and combine together again to form a combined stream F4 that then travels in a flow direction I through the fuel outlet 232 to discharge out of the anode flow channel plate 23.

The anode flow channel plate 23 further comprises a plurality of raised blocks 24, and each of the blocks 24 has an end (the upper side) connected to the non-through zone 221b of the anode collector 221 and an opposite end (the lower side) connected to the bottom plate 23e of the anode flow channel plate 23. An area of the non-through zone 221b of the anode collector 221 connected by the blocks 24 and the walls 23a, 23b, 23c, 23d is bigger than an area of the through zones 221a connected by the blocks 24 and the walls 23a, 23b, 23c, 23d. The blocks 24 are arranged at locations close to an inside surface of each wall 23a, 23b, 23c, 23d that faces toward the fuel transmission channel 233 and an open space or gap (not labeled) is set between adjacent blocks 24. In addition, an open space or gap 241 is present between the blocks 24 and the walls 23a, 23b, 23c, 23d. The open space 241 is in communication with the open spaces between the blocks 24. The blocks 24 and the walls 23a, 23b, 23c, 23d are arranged in such a way that the open space 241 corresponds in position to the through zones 221a of the anode collector 221.

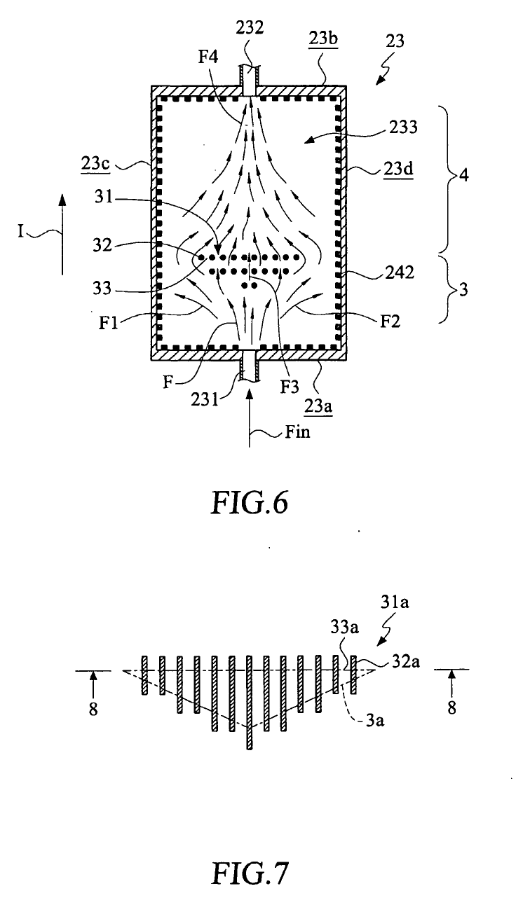

Preferably, the blocks 24 may be formed as teeth (see FIG. 6) that are integrally formed on the inside surfaces of the walls 23a, 23b, 23c, 23d to enhance uniformization of the flow field within the fuel transmission channel 233. Particularly, the blocks 24 has an outward-facing side integrally connected to the inside surfaces of the walls 23a, 23b, 23c, 23d and an inward-facing side extending into to the fuel transmission channel 233.

With the equalization structure 31, which is formed of a plurality of fluid guiding blocks 32, provided at the fluid equalization zone 3 of the fuel transmission channel 233, when the fuel jet stream F of the anode fuel Fin flows through the open spaces 33 between the fluid guiding blocks 32, the fuel stream F efficiently brings away the product, such as CO₂, of the reaction thereof occurring at the anode collector 221, whereby the reaction product does not interfere with or hinder the diffusion of oxide. The circulation zone 151 that is observed in the conventional fuel cell 100 is eliminated, which helps providing a mounting force to the membrane electrode assembly 2, and the flow field within the fuel transmission channel 233 is made uniform. Further, the arrangement of the blocks 24 increases the contact area between the oxide and the anode collector 221 and helps protecting the fluid guiding blocks 23 from deformation.

Further, the fluid guiding blocks 32 is constructed to have a cross-sectional area that is substantially smaller than the non-through zone 221b of the anode collector 221 whereby the fuel jet stream F of the anode oxide Fin may be made further uniform when flowing through the equalization structure 31.

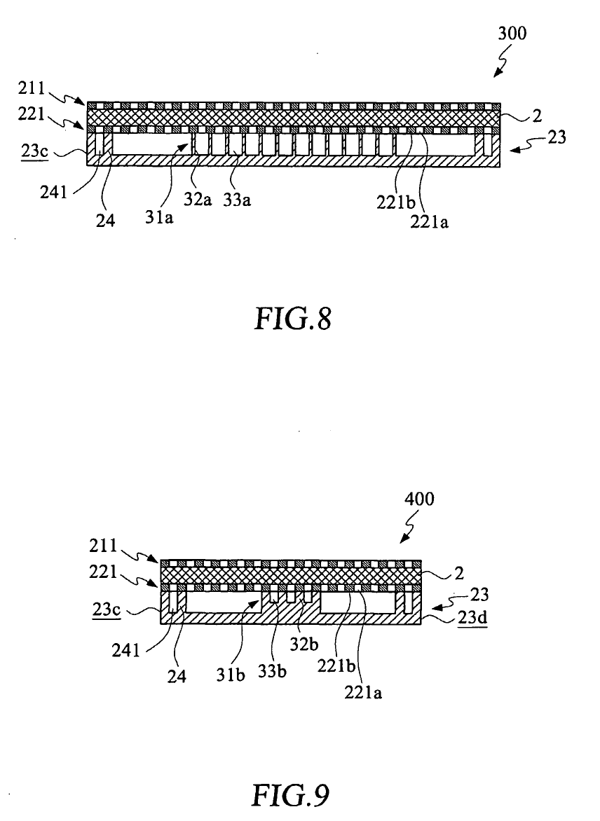

In the previous embodiment discussed with reference to FIGS. 3 to 6, the equalization structure 31 is comprised of a plurality of properly distributed fluid guiding blocks 32. However, the fluid guiding blocks 32 may be replaced by other equivalent structures, such as those that will be illustrated in a second embodiment of the present invention with reference to FIGS. 7 and 8. In a direct oxide fuel cell, broadly designated at 300, in accordance with the second embodiment of the present invention, an equalization structure 31a is arranged in the fuel transmission channel 233, comprising a plurality of fin plates 32a mounted in a fluid equalization zone 3a of the anode flow channel plate 23. Each fin plate 32a is extended in a direction substantially perpendicular to a first wall 23a of the anode flow channel plate 23 that is formed with the fuel inlet 231. The fin plates 32a are spaced from each other so that an open space or gap 33a is defined between adjacent ones of the fin plates 32a to help uniformization of the flow field of the fuel stream F of the anode fuel Fin in the anode flow channel plate 23.

Preferably, each fin plate 32a has a thickness or width in a direction that is normal to the extension of the fin plate 32 and the width is small enough to be accommodated in the non-through zone 221b of the anode collector 221 without substantially covering or blocking the through zones 221a. In addition, blocks 24 are similarly provided in the anode flow channel plate 23 at locations adjacent to the inside surfaces of the walls 23a, 23b, 23c, 23d of the anode flow channel plate 23 to facilitates uniformization of the flow field of the fuel stream F of the anode fuel Fin.

Referring to FIG. 9, which shows a direct oxide fuel cell constructed in accordance with a third embodiment of the present invention, generally designated with reference numeral 400, the fuel cell 400 is provided with an equalization structure 31b that is set in a fluid equalization zone 3b. The equalization structure 31b comprises an island area like structure comprising a raised portion having a top from which a plurality of fluid guiding blocks 32b extend. The fluid guiding blocks 32b are arranged to correspond in positions to the non-through zones 221b of an anode collector 221. An open space 33b is formed between adjacent ones of the fluid guiding blocks 32b and the open spaces 33b correspond in positions to through zones 221a of the anode collector 221.

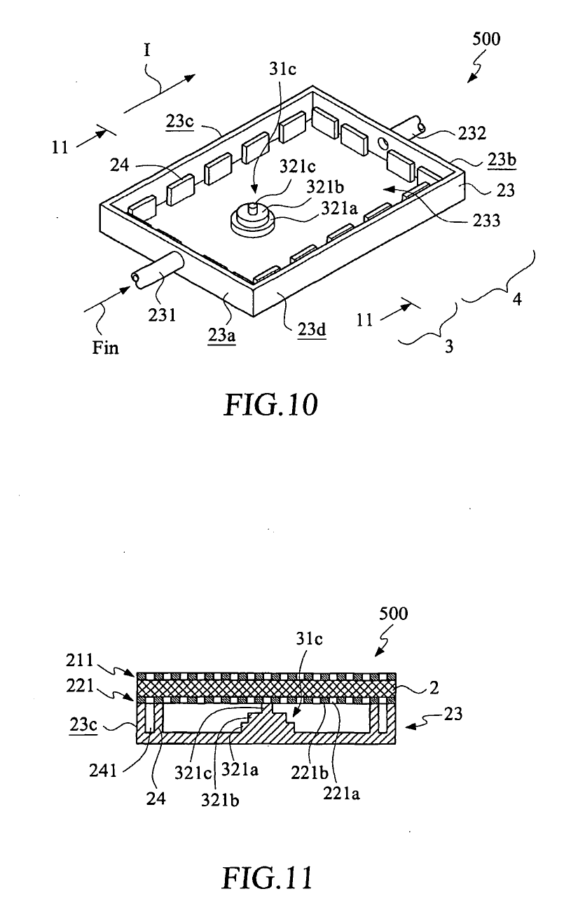

Referring to FIGS. 10 and 11, which show a direct oxide fuel cell constructed in accordance with a fourth embodiment of the present invention, generally designated with reference numeral 500, the direct oxide fuel cell 500 comprises an equalization structure 31c that is set in a fluid equalization zone 3c. The equalization structure 31c comprises a stepped structure that consists of a plurality of cylindrical structures of different diameters that are stacked in such a way that the equalization structure 31c is reduced in diameter in a stepwise manner in a direction from the anode flow channel plate 23 to the anode collector 221. In other words, and as a preferred embodiment, the equalization structure 31c includes a first-step equalization structure 321a, a second-step equalization structure 321b having a cross-sectional area smaller than the first-step equalization structure 321a, and a third-step equalization structure 321c having a cross-sectional area that is even smaller than the second-step equalization structure 321b.

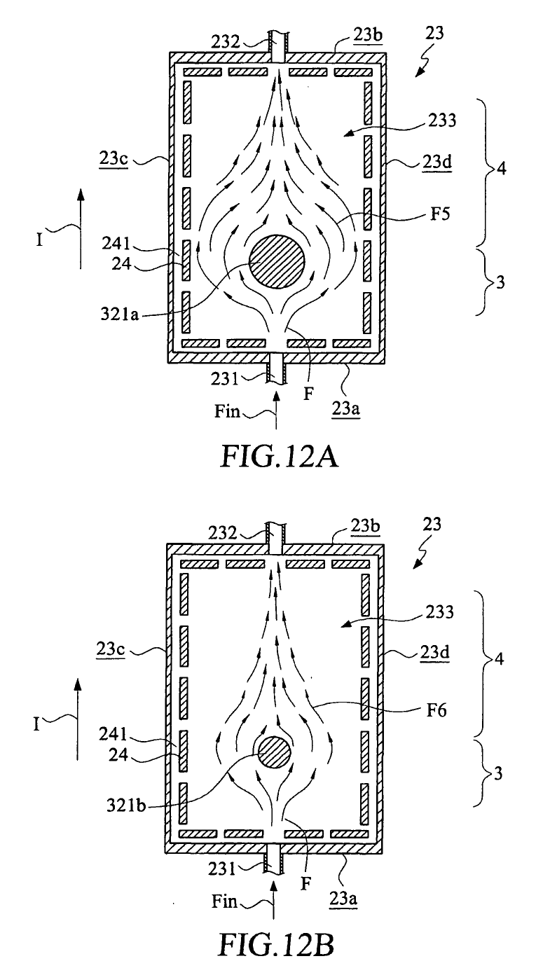

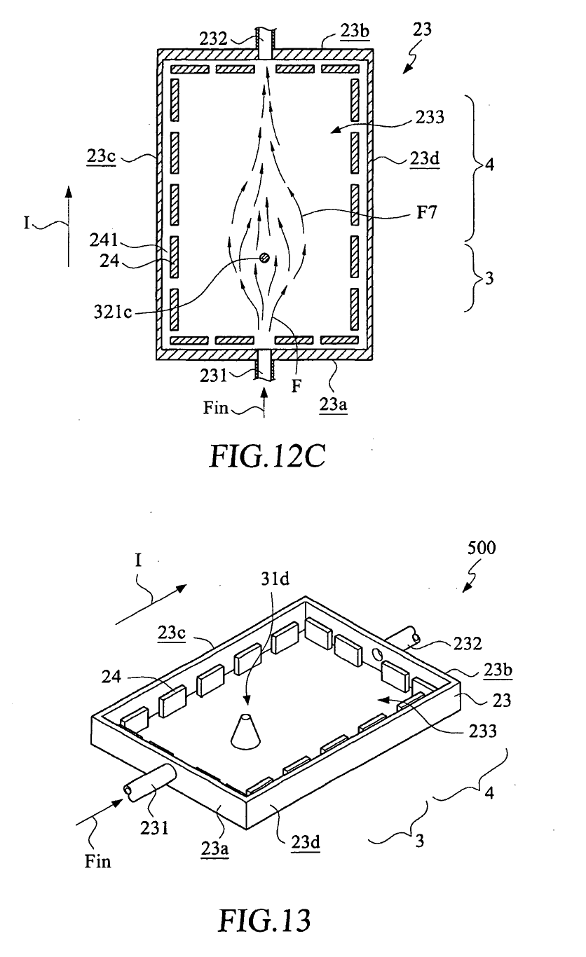

Referring to FIGS. 12A to 12C, the flow fields of the anode fuel Fin at the first-step, second-step, and third-step equalization structures are illustrated. When a fuel jet stream F of the anode fuel Fin is supplied into the anode flow channel plate 23 and moves through the equalization structure 31c, the fuel stream F is split into different branch streams by each step. For example, when the fuel stream F of the anode fuel Fin passes through the first-step equalization structure 321a, the fuel stream F is split by the cylinder of the first-step equalization structure 321a into branch streams F5 that travel through a wide area inside the fuel transmission channel 233. When the fuel stream F flows over the second-step equalization structure 321b, due to the shearing effect induced by the viscosity of the fluid and being subject to the flow field at different steps of the equalization structure 31c, branch streams F6 travels through an area smaller than that of the branch streams F5 of the first-step equalization structure 321a. Similarly, the third-step equalization structure 321c forms branch streams F7 that travel an area that is even smaller than that of the branch streams F6. As a consequence, a uniform overall flow field can be established. In addition, since the third-step equalization structure 321c has the smallest cross-sectional area among all the steps 321a, 321b, 321c, there will be no adverse effect on the contact between the fuel stream F and the anode collector 221.

Thus, due to the stepped structure of the equalization structure 31c and further due to the shearing effect induced by the viscosity of the fuel stream, when the first-step branch streams F5 are forced to change moving direction by the first-step equalization structure 321a, the second-step branch streams F6 and the third-step branch streams F7 of the upper steps are caused by shearing force to move. Thus, although, as compared to the first-step branch streams F5, the second-step branch streams F6 and the third-step branch streams F7 are affected less by the stepped equalization structure 31c, the flow fields of the fuel stream F passing through each step of the stepped equalization structure 3c may still be substantially uniformized.

The reduced step structure of the equalization structure 31 may be modified and replaced by a taper structure 31d, as shown in FIG. 13, or any other structures having geometry of which the cross-sectional area is dimensionally gradually reduced in a direction from the anode flow channel plate 23 to the anode collector 221. With such a reduced structure, the shearing force between different layers of flow of the anode fuel induces a driving force acting on different layers to uniformize the flow field among different layers.

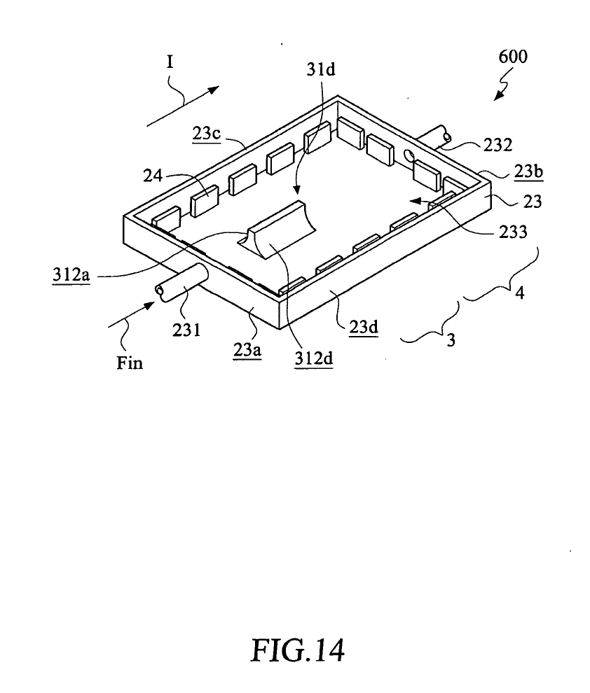

FIG. 14 shows an anode flow channel plate 23 employed in a direct oxide fuel cell, which is constructed in accordance with a fifth embodiment of the present invention and is designated with reference numeral 600. The anode flow channel plate 23 of the fifth embodiment has formed therein a fluid equalization zone 3d in which an equalization structure 31d is set. The equalization structure 31d is a trapezoidal structure having two side surfaces 312a, 312b that are concave and form curved side surfaces, which similarly realize uniformization of flow field of the fuel stream and facilitate driving upper layers of the fuel stream F to move.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A direct oxide fuel cell, comprising:
a membrane electrode assembly having a cathode side and an anode side;
a cathode collector disposed on the cathode side of the membrane electrode assembly;
an anode collector disposed on the anode side of the membrane electrode assembly, the anode collector forming a plurality of through zones and non-through zones;
an anode flow channel plate disposed on a side of the anode collector facing away from the membrane electrode assembly, the anode flow channel plate including a fuel transmission channel with a fuel inlet and a fuel outlet; and
an equalization structure disposed in the fuel transmission channel and having an end connected to the anode flow channel plate and an opposite end abutting against the anode collector, wherein an area of the non-through zones abutted by the equalization structure is bigger than an area of the through zones abutted by the equalization structure.

2. The direct oxide fuel cell as claimed in claim 1, wherein the opposite end of the equalization structure abuts against a portion of the non-through zones of the anode collector.

3. The direct oxide fuel cell as claimed in claim 1, wherein the equalization structure is disposed between the fuel inlet and the fuel outlet.

4. The direct oxide fuel cell as claimed in claim 1, wherein the equalization structure comprises a plurality of fluid guiding blocks, the fluid guiding blocks being spaced from each other so that an open space is present between adjacent fluid guiding blocks.

5. The direct oxide fuel cell as claimed in claim 4, wherein the open space corresponds to the through zones of the anode collector, and each of the fluid guiding blocks abuts against the non-through zones of the anode collector.

6. The direct oxide fuel cell as claimed in claim 4, wherein the fluid guiding blocks are arranged to form an area of an inverted triangular shape as viewed in a direction from the fuel inlet to the fuel outlet.

7. The direct oxide fuel cell as claimed in claim 4, wherein the fluid guiding blocks are distributed in a direction substantially parallel to a wall of the anode flow channel plate in which the fuel inlet is formed and are spaced from each other.

8. The direct oxide fuel cell as claimed in claim 1, wherein the anode flow channel plate comprises a bottom plate and a plurality of walls disposed on the bottom plate, and an edge of the walls being connected to the anode collector so that the anode collector, the walls, and the bottom plate together delimit the fuel transmission channel.

9. The direct oxide fuel cell as claimed in claim 8, wherein the walls comprise a first wall and a second wall opposite to each other, and the fuel inlet and the fuel outlet are respectively formed in the first wall and second wall.

10. The direct oxide fuel cell as claimed in claim 8, wherein the anode flow channel plate further comprises a plurality of blocks, one end of each of the blocks is connected to the anode collector, the blocks being arranged at locations close to an inside surface of each of the walls facing toward the fuel transmission channel, an open space being present between adjacent blocks, and the open space corresponds to the through zones of the anode collector.

11. The direct oxide fuel cell as claimed in claim 10, wherein each of the blocks has a surface connected to the inside surface of the wall and an opposite surface extending into the fuel transmission channel.

12. The direct oxide fuel cell as claimed in claim 10, wherein each of the blocks has an opposite end connected to the bottom plate, each of the blocks and the respective one of the walls forming an open space that communicates the open space formed between the adjacent blocks.

13. The direct oxide fuel cell as claimed in claim 10, wherein an area of the non-through zones connected by the walls and the blocks is bigger than an area of the through zones connected by the walls and the blocks.

14. The direct oxide fuel cell as claimed in claim 1, wherein the equalization structure comprises a structure having a cross-sectional area that is gradually reduced in a direction from the anode flow channel plate to the anode collector.

15. The direct oxide fuel cell as claimed in claim 14, wherein the equalization structure comprises a taper structure.

16. The direct oxide fuel cell as claimed in claim 14, wherein the equalization structure comprises a stepped structure of the equalization structure.
